(19) United States
(12) Patent Application Publication
(10) Pub. No.: US 2009/0094466 A1
(43) Pub. Date: Apr. 9, 2009

(54) PROCESS FIELD DEVICE WITH AUGMENTED LOOP POWER AND WIRELESS COMMUNICATION

(76) Inventors: Kerry R. Matthew, Clinton, MA (US); Wayne G. Shumaker, Hopkinton, MA (US); Patrick J. Moran, Shrewsbury, MA (US)

Correspondence Address: Anderson Gorecki & Manaras LLP, 33 NAGOG PARK, ACTON, MA, 01720, US

(21) Appl. No.: 12/059,447

(22) Filed: Mar. 31, 2008

Related U.S. Application Data
(60) Provisional application No. 60/977,389, filed on Oct. 4, 2007.

(51) Int. Cl. G06F 1/26

(52) U.S. Cl. 713/300

(57) ABSTRACT

A system for controlling and measuring a power source switches between a first source and a second source in rapid succession to help maintain function of a load. In particular, a primary source may be replaced or augmented by an auxiliary source. Fast switching is achieved by delivering current to the output load through a nonlinear device. A record of conditions when the power sources switch modes is maintained in memory. The record is used to anticipate subsequent mode switching events.

### CROSS-REFERENCE TO RELATED APPLICATIONS

A claim of priority is made to U.S. Provisional Patent Application Ser. No. 60/977,389 entitled WIRELESS COMMUNICATION SYSTEM, filed Oct. 4, 2007, which is incorporated by reference.

### FIELD OF THE INVENTION

This invention relates generally to industrial process control or monitoring systems, and more specifically to process field devices capable of wireless communication, such as radio frequency (RF) communication.

### BACKGROUND OF THE INVENTION

In industrial settings, process control or monitoring systems may be used to control and/or monitor the parameters or outcomes of various industrial processes. Typically, a control or monitoring system uses field devices that are distributed at key locations in an industrial process and that have some connection to a remotely located process controller or process monitor. A field device may be any device that performs a distributed function in a process control or process monitoring system. Field devices may include sensors, actuators, or other devices.

In a typical process control or monitoring system, each field device has been coupled to a process controller or process monitor using a process control loop. In many installations, the process control loop is also used to deliver a current to the field device for powering the field device. The process control loop may also be used to transmit data from the field device; for example, sensor data may be transmitted to a process monitor via the process control loop.

In many process control or monitoring systems, the process control loop is a two-wire process control current loop, with a single two-wire control loop used to connect each field device to a process controller or process monitor. For example, a 4-20 mA current loop is commonly used to power field devices and transmit sensor information in many process-monitoring applications. In such a loop, a proportional current may be used to represent a sensor output, with 4 mA typically representing the sensor's zero-level output and 20 mA typically representing the sensor's maximum output. The sensor's output voltage may be converted to a proportional current between 4 and 20 mA and transmitted along the current loop. A receiver at the remote end (for example, at a process monitor) may convert the 4-20 mA current back into a voltage, which may be further processed to extract sensor data.

Modern process control and process monitoring applications may also use wireless technologies to transmit data. For example, radio frequency (RF) communication may be used to transmit sensor data from a field device to a process monitor or process controller.

Since the process control system depends on the DC value of the process control loop current to signal between existing field-devices, the power extracted from the loop must be done in such a way that it does not disturb existing field device operation. By managing the voltage and current in the process control loop, the excess energy may be utilized for powering a wireless communication system without disturbing the process control loop.

The power available during normal operating conditions is the product of the available current and available voltage drop across the power extraction system. In certain situations, the available voltage drop in the loop is sometimes limited to 1.4 volts or less while the current available is 4 mA. Thus, the maximum continuous power from this configuration is 5.6 mW. This is insufficient for use in a system that has a radio or other system component that uses more than 5.6 mW. For example when a radio is transmitting at a power level of 10 dBm (10 mW) the power available is insufficient to enable sustained operation from loop power alone. In this case, it is desirable to augment the loop with other power sources. It is also desirable to have a means of controlling the power source so that the loop power and other measurements are available for use within the larger system. In addition, there is a desire to have a mechanism to signal a local controller with information about the power consumption in terms of who is sourcing the power along with a measure of the quantity of energy supplied by that source. This information may be used to make decisions about how to use the available power sources to maintain control and communication within the larger system.

Various aspects of the invention described below relate to a process field device with augmented loop power and wireless communication.

### SUMMARY OF THE INVENTION

In accordance with one embodiment of the present invention, a system for controlling and measuring a power source switches from a first source to a second source in rapid succession to help maintain function of a load during power transients. Fast switching is obtained by allowing each source to deliver current to the output load through a nonlinear device such as a Schottky diode. Power sources that have different characteristics in terms of capacity, reliability, temperature characteristics and schedule, for example, are configured to pump current through an inductive boost or buck power switching device. As the power sources switch modes, a signal is sent to a local controller that records the history of the energy delivered by the source in use. By using the history of the power delivered, the system anticipates switch points for enhanced power use among the available sources. The choice of the power source candidates is enabled through a predetermined setting, configured by an active controller algorithm. This algorithm, which is stored in temporary or permanent memory, determines the criteria under which the power extraction is sequenced. The method that determines the extraction criteria may or may not change over time, and operates in a way that helps provide continuous operation. This helps to provide proper data communications within the system and allows other nearby elements that contain additional historical data to share information relevant to the settings for enhanced energy management. In such cases, the temperature conditions, for example, may be known and made available by communicating to another device at a distant location, but within the system. Temperature can be a good predictor of energy supply performance and may be used to indicate the limits the power source. This and other environmental factors allow the wireless communicator to prepare for a power transient.

The invention may include means of measuring the performance of the local power sources as is described in the present embodiment. The system may choose to use a portion of the power from one source and another portion of the power from another source. The ratio of the power used in the system is adjusted by selecting the arrangement of components and the timing of the current pumps from each of the available sources. Generally, there are two categories of power sources; a current source, which is characterized by a high impedance source, and a voltage source, which is characterized by a low impedance source. When the available source is a current source, the current-mode power extraction circuit is used to regulate and control the energy delivered to the system. When the available source is a voltage source, such as a primary cell, the voltage mode circuit is used to regulate and control the energy delivered by the system. When these two types of power sources are configured to use a charge pump, their outputs are tied together so that only one pump is working at a given time. Furthermore, the pumps signal their operating conditions back to a control system.

Energy is defined by the power used over a given period. A primary cell is manufactured with a preset, stored energy and is replaced when that energy is dissipated. The energy used in a primary cell is recorded to maintain the state of the available energy such that the system can determine the optimum usage configuration and can determine the point that the primary cell will be empty.

Energy delivered by a charge pump is obtained by observing that the charge delivered by the pump at a known voltage is equivalent to the average length of time that the current is flowing in the pump inductor over the total time the charge pump is running. Since the average current is set by the inductance and duty cycle of the charge pump then the energy delivered is proportional to the voltage squared of the power source.

Additional functionality of the power switching algorithms include the ability to select portions of the circuits that are enabled or disabled depending on the requirements of a specific application within the system. Some portions of the system are needed only during communication among internal sections and subsystems but not during communication over the radio. These systems are disabled using a sequence of operations that interact with the information obtained from the various power extraction schemes. When the selection of the disabled subsystems conditions create a situation where a latch up condition may occur, the sequenced the load current is used to detect this condition within the system thus allowing the algorithm to take corrective action before the energy supply is depleted. The latch-up condition shown in FIG. 12, where one of the subsystems 116 within the system has been de-powered by power switch 119, delivers a load current 110 to the system increases because connected 111 powered subsystems 117 drives the de-powered subsystem 109 through its output buffer 112 into the forward biased substrate diode 113 and other internal circuits 120 of the de-powered subsystem 116. This errant condition, once determined, can be remedied by removing all power to the inputs of the de-powered device by properly disengaging 114 the output drive of the powered subsystem. The output drivers of the powered subsystem are controlled through an algorithm that uses the signals 55 from the power-extraction circuit 52.

A system that admits control of a selected source of power and that detects and measures its own performance is shown in the FIG. 6. In this system, there are two or more power sources and means of measuring their energy usage. The power delivered is the voltage applied times the current used by the load. The energy measured is determined by the summation of the power supplied by the source for a given set of time. In current-mode operation, the voltage applied to the charge pump is set by a local controller and a signal is generated by the charge pump that indicates the length of time that the known current is injected into the load. This arrangement works best when the drop in the loop can be controlled by the power-extraction subsystem.

In a system that is driven by a voltage source, the current must be regulated in the power-extraction subsystem. In FIG. 6, the current mirror 81, 82 is set for the nominal current configuration and is adjusted to starve the current into the charge pump 77c. In this mode, the charge pump stops operating which allows the controller to adjust the current upwards until the current is not starved and the drop across the mirror is negligible. Once the system is operating in this mode, the energy delivered is proportional to the pulse width of the signal generated 55 by the charge pump in the power extraction subsystem 52.

### BRIEF DESCRIPTION OF THE DRAWINGS

Aspects of the invention are described below with reference to the following drawings in which like numerals reference like elements, and wherein:

FIG. 1 shows an embodiment of a process monitoring or process control system.

FIG. 2 illustrates the consequences that may arise when power is lost to a field device.

FIG. 3 shows a block diagram of a segment of a representative process monitoring system using wireless communication.

FIG. 4 shows a partial block diagram of a representative embodiment of a wireless adaptor.

FIG. 5 illustrates how a local auxiliary power source may provide additional power for wireless data transmission and other operations.

FIG. 6 is a schematic diagram of a current-mode and voltage-mode power-extraction system showing connection of multiple sources to the output load.

FIG. 7 illustrates the current flow in a current-mode power-extraction embodiment.

FIG. 8 shows a block diagram of a current-mode power-extraction method.

FIG. 9 illustrates the current flow in a voltage-mode power-extraction embodiment.

FIG. 10 shows a block diagram of the voltage-mode power-extraction method.

FIG. 11 shows a block diagram of the voltage-mode power extraction method used with a primary power source.

FIG. 12 illustrates the method of detecting and correcting a latch-up condition in de-powered subsystems.

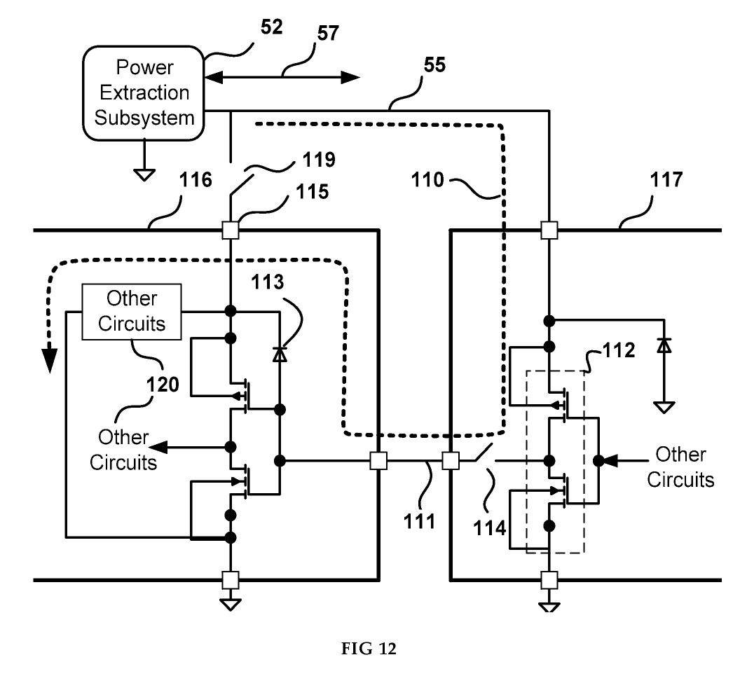

FIG. 13 illustrates the use of variable ballast energy-storage devices to enable rapid power up.

### DETAILED DESCRIPTION OF ILLUSTRATIVE EMBODIMENTS

Aspects of the invention are described below with reference to illustrative embodiments. However, it should be understood that aspects of the invention are not limited to those embodiments described below, but instead may be used in any suitable system or arrangement.

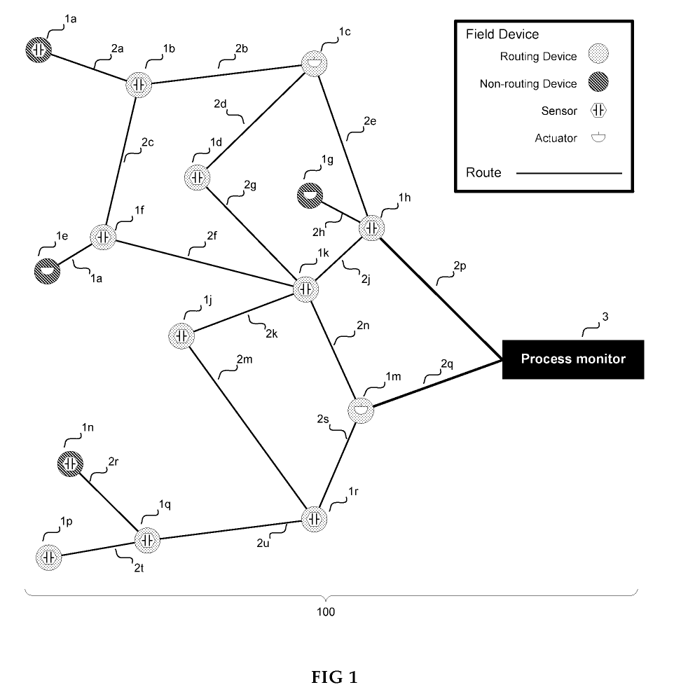

As illustrated in FIG. 1, aspects of the invention are described in relation to a process monitoring or process control system 100 (hereafter referred to as a process monitoring system 100), in which field devices 1 may be used to monitor and/or control industrial processes or other process, and in which data may be transmitted from the field devices 1 to a process monitor or process controller 3 (hereafter referred to as a process monitor 3). Routes 2 between a field device 1 and the process monitor 3 or between two field devices 1 may represent data transmission routes within the process monitoring system 100.

Aspects of the invention are also described in relation to a process monitoring system 100 in which data may be transmitted wirelessly between a process monitor 3 and a field device 1, or between field devices 1. In the example shown in FIG. 1, the data transmission routes 2 may be wireless. In a preferred embodiment, wireless transmission may utilize radio frequency (RF) communication. However, the methods described herein are not limited to such an embodiment, and other wireless data transmission methods may be utilized.

### Drawbacks of Control Loop Power

Two-wire process control loop systems 100 offer a simple way to retrieve data from field devices 1 while also providing power to those field devices 1. However, there are a number of drawbacks that may be apparent when using a process monitoring system 100 with a process control loop. For example, process monitoring systems 100 using only a process control loop for power are entirely dependent on external sources of power. This means that the process control current loop (hereafter referred to as loop power 4) is the only source of power for a field device 1. An interruption in loop power 4 may result in an interruption in operation of the process monitoring system 100. This may affect only a single field device 1 in some cases, or it may affect a group of field devices 1, such as when a plant-wide power interruption occurs.

Systems that utilize a 4-20 mA current loop for power to field devices 1 are also dependent on available loop current. As noted previously, in a 4-20 mA current loop, data may be sent along the loop by converting a voltage (for example, from a sensor measurement) to a proportional current and transmitting that current along the current loop. However, the proportional current may not be sufficient to supply the power requirements of a field device 1, in particular the power required for wireless communication by the field device 1.

In process control systems 100 that harvest power solely from a 4-20 mA current loop, a substantial delay may occur between the time when a field device 1 is connected to the system 100 and the time when sufficient power has been collected and stored to operate the field device 1. Such a delay may result in the loss of key monitoring data for a location or function in an industrial process. Additionally, interruption of loop power 4 to a single field device 1 may result in interruption of data transmission from all field devices 1 that relay data through the field device 1 with interrupted power.

Process monitoring systems 100 using RF or other wireless communication methods may utilize interdependent field devices 1. A number of wireless communication protocols rely on field 1 organized into a grid, mesh, or star-mesh configuration (hereafter referred to as a mesh wireless system). The example in FIG. 1 shows field devices 1 in a star-mesh configuration. In a system 100 using this type of protocol, a field device 1 that is near a process monitor 3 may send its data directly to the process monitor 3, but a field device 1 that is some distance from the process monitor 3 may relay its data along a route 2 through other field devices 1 to the process monitor 3.

However, some field devices 1 may be situated so that another route 2 is not readily accessible due to a temporary or transient network condition. Transient conditions may occur when a portion of the process is brought off line for service, or when a transmission path is temporarily blocked by mobile objects. In such cases, it may be desirable to have a secondary power source that may be harvested from the environment and may be readily available as a reserve source to provide reliable process data transmission.

Interruption of loop power 4 to a single field device 1 may result in interruption of data transmission from all field devices 1 that relay data through the field device 1 with interrupted power. Often, mesh wireless systems may be configured to be self-healing, so that a field device 1 can locate another route 2 if its normal route 2 is interrupted. However, some field devices 1 may be situated so that another route 2 is not readily accessible. In such cases, interruption of power on one process control current loop for a single field device 1 may affect data transmission for multiple field devices 1.

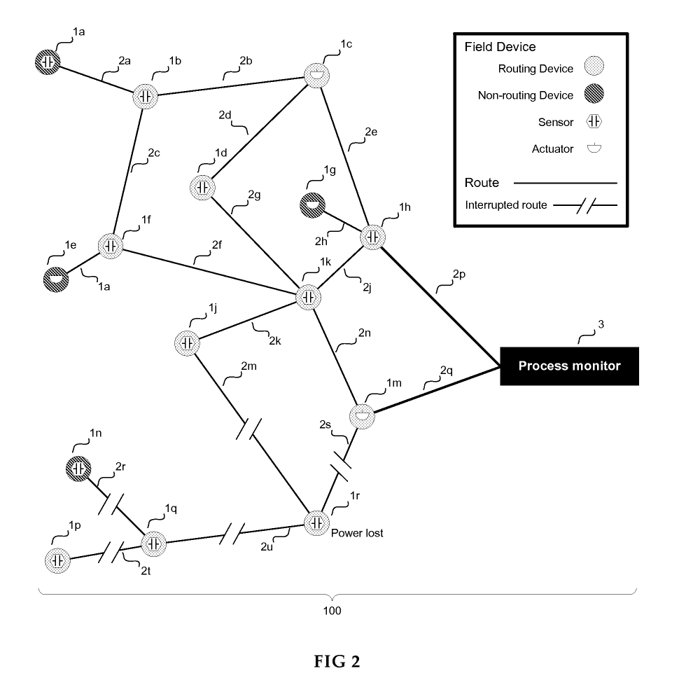

FIG. 2 illustrates the consequences that may arise when power is lost to a field device. In FIG. 2, field device 1r has lost loop power 4. This field device 1r no longer has an available route 2s to the process monitor 3, and has thus lost its ability to function, including its ability to transmit or receive data to or from the process monitor 3 and to other field devices 1. The normal routes for data transmission for field devices 1n, 1p, and 1q traveled through field device 1r, and no other route 2 is readily available for field devices 1n, 1p, and 1q. Thus, if operation is interrupted for field device 1r, operation may also be interrupted for field devices 1n, 1p, and 1q, even if field devices 1n, 1p, and 1q still have loop power 4.

For these reasons and more, it may be desirable to provide an additional local source of power that augments available loop power 4.

### Augmenting Loop Power

This invention takes advantage of additional power sources local to a field device 1 to augment available loop power 4. This may lessen dependency on an external power source and may reduce dependency on available loop current for field device 1 operation.

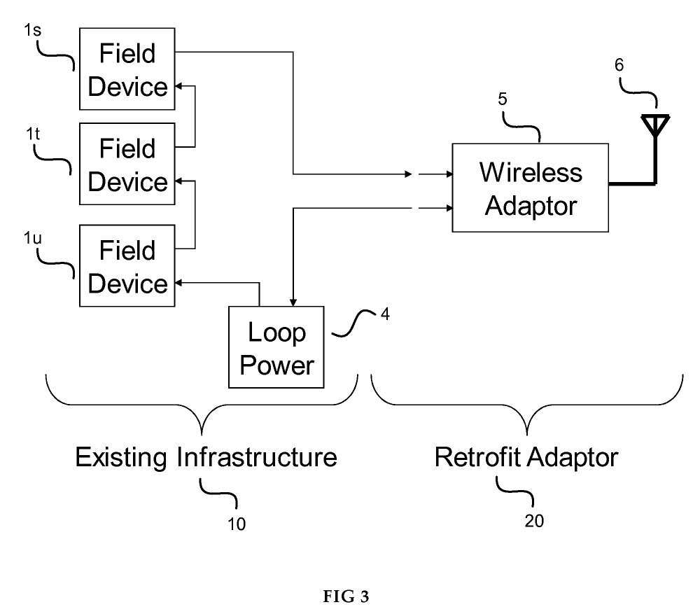

FIG. 3 shows a block diagram of a segment of a representative process monitoring system 100 using wireless communication. Loop power 4 is available to the field devices 1. The field devices 1 and loop power 4 may be elements of an existing infrastructure 10. A wireless, self-powered adaptor 5 may be retrofitted 20 to connect to the existing infrastructure 10. The wireless adaptor 5 may provide a wireless connection 6, as well as the ability to select available power sources.

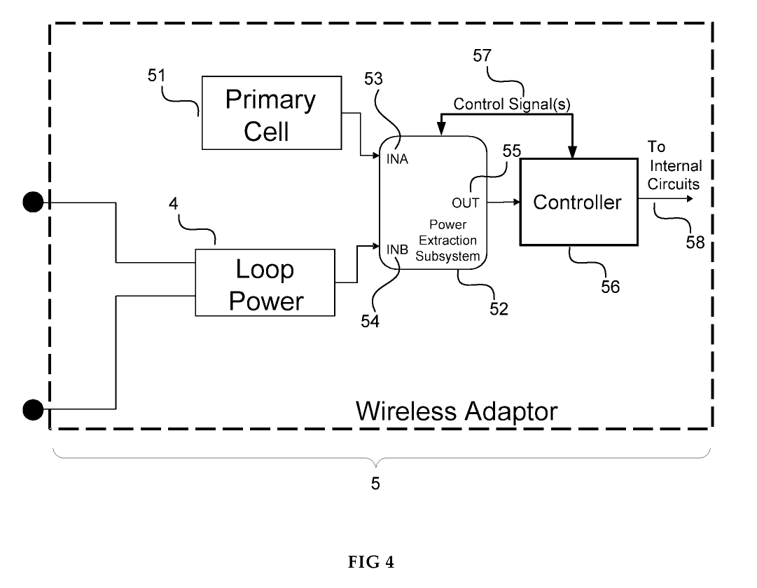

FIG. 4 shows a partial block diagram of a representative embodiment of a wireless adaptor 5. Within the wireless adaptor 5, a power extraction mechanism 52 may enable extraction of power input. As shown in the representative embodiment in FIG. 4, power inputs may include a local power source via a primary cell 51 (via input INA 53) and/or loop power 4 (via input INB 54). At least one power source may be selected from the available power sources 51 and 4; by selecting a local power source via a primary cell 51, dependency on loop power 4 may be lessened. A controller 56 in the wireless adaptor 5 may receive power (via output OUT 55) as selected by the power extraction mechanism 52. The controller 56 may also send control signals 57 back to the power extraction mechanism 52. The controller 56 may be connected to other internal circuits 58 within the wireless adaptor 5, as required for adaptor operation.

As used in the invention, local power sources may include solar cells, harvesters that convert mechanical energy (such as vibrations) to electrical energy, collectors of stray electromagnetic radiation, wind turbines, tidal power collectors, systems powered by wave action, geothermal systems, systems using thermoelectric effects, systems using temperature or pressure differentials, and other power sources. Although different power sources may be appropriate for different installations, depending on the details of the installation (for example, tidal power systems require proximity to the ocean), any suitable local power source may be utilized as described herein. A standard interface may be used to connect the local power source to the field device 1, allowing the field device 1 to access the local power source, in addition to loop power 4.

The use of local sources to augment loop power 4 may provide additional power for wireless communication by a field device 1. For example, a field device 1 with a sensor and a radio for RF communication may require a baseline power level for sensor operation, but may require additional power for radio operation. In such case, loop power 4 may be sufficient to provide the baseline power requirements, and a local power source may be used to augment power as required for wireless data transmission. Certain communication links may require the combination of the loop power 4 for steady state operation and augmented power for peak loads.

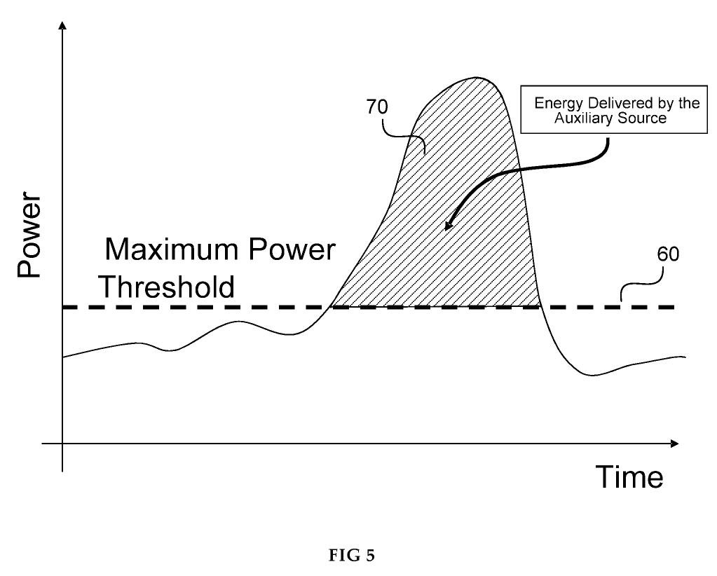

FIG. 5 illustrates how an auxiliary power source may provide additional power for wireless data transmission and other operations. The maximum power threshold 60 represents the maximum power that may be available from the control loop. As noted in a previous example, this power level 60 may be sufficient for sensor operation, but may be insufficient for radio operation. The a priori power load of the radio may vary significantly depending on the radio that is used. A local power source used as an auxiliary power source may provide a power boost 70 when the power load is greater than the maximum power 60 available from the control loop. Thus, the use of local sources to augment power decouples power requirements from functional requirements of a device.

The use of augmented power may also support the self-healing nature of mesh wireless systems, in that the loss of loop power 4 by a single field device 1 may be less likely to result in interruptions in data transmission throughout a mesh. If loop power 4 is interrupted for a field device 1 at a key location in a mesh (such as field device 1r in FIG. 2), a local power source may be used to power the field device 1, thus enabling the field device 1 to continue to receive, transmit, and relay data through the mesh. Essentially, the local power source may act as a backup power source, limiting disruptions in the wireless mesh.

All devices, including the wireless adaptor 5, may be routing devices. Thus, even when loop power 4 is lost to a device or set of devices and a local power source is providing the sole source of power for a device or set of devices, wireless communication with the rest of the mesh may be maintained, and routing through the mesh may not be interrupted.

In some embodiments, augmenting loop power 4 with other local power sources may also reduce lag time between field device 1 installation and power availability (for example, when power is collected and stored even before a field device 1 is installed and activated). As one example, a field device 1 utilizing a harvester of vibrational energy may collect such energy during field device 1 transport. The collected energy may be made available to the field device 1 as soon as the field device 1 is installed.

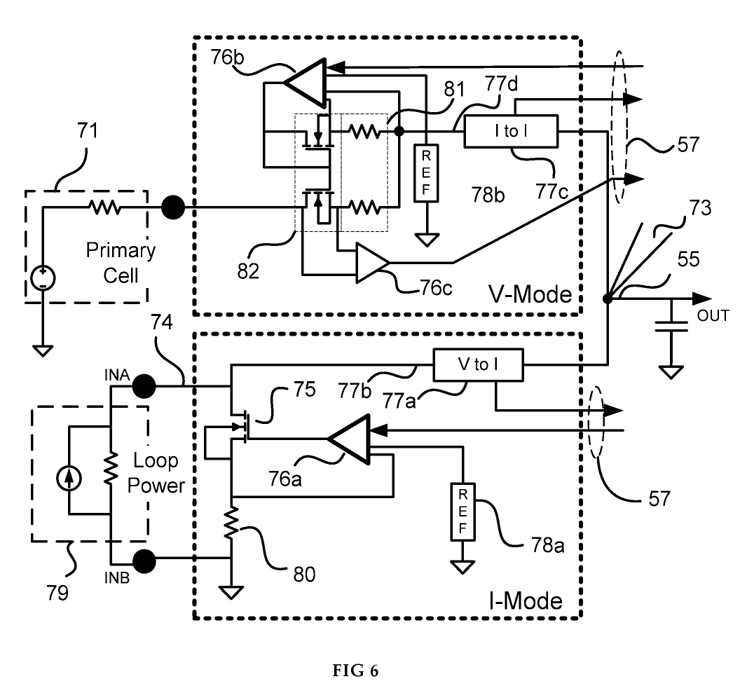

FIG. 6 represents a schematic of an arrangement of 2 power extraction circuits. In this schematic, there is 1 source, a primary cell, 71, and a second source, a process control loop, 79, which represent a voltage-mode source and current-mode source respectively.

In the current-mode power-extraction subsystem there is sense resistor, 80, that is used by the instrumentation amplifier, 76a, to control the voltage at the input, 77b, of the charge pump, 77a. A voltage to current pump, 77a, has an internal diode rectifier converts the voltage at 77b to a current output that is summed at the current summing node, 73. Output 55 is provided by the summation of current from one or more current sources to charge a capacitor or other energy storage device at node 73. In the current-mode power-extractor, the instrumentation amplifier, 76a, is controlled by a reference, 78a, and other control signals in order to set the proper loop voltage. When a charge pulse is delivered to the output capacitance, current pump, 77a, sends a signal to the local controller that measures the duration of the fixed charge delivered to the load. By using the preset voltage at node 77b and the preset current, defined in the Voltage to Current Pump, 77a, the energy delivered by the current-mode power-extraction is recorded in the local controllers' local memory.

When a voltage source, 71, is used to supply energy to the system, a voltage-mode power-extractor is used. The voltage applied to the input of the charge pump, 77d, is dependant on the current used by the input of the charge pump. The output current of the charge pump is a fixed by design. The loss and efficiency of the converter determines the current used by the input of the charge pump. The variable input current of the charge pump, 77d, will vary the applied voltage because of the internal parasitic resistance within the primary cell, 71. In order to determine the current used by the current pump, a current mirror, 81, 82, is used to detect the threshold where the current used by the pump, 77, matches the current available from the mirror, 81, 82. When the mirror is starving the current pump, a comparator, 76c, detects the drop across the current regulator and signals the controller to adjust the set current either up buy using the set current control input control point. The degeneration resistors, 81, are used to scale the control current within the proper range for operation with the expected load.

By setting the references 78a and 78b, the initial operating conditions for the system ensure that the power sources are operating without an active local controller. When the internal controller becomes active, the Set Voltage and Set Current feedback mechanisms may be used to tune the power source usage.

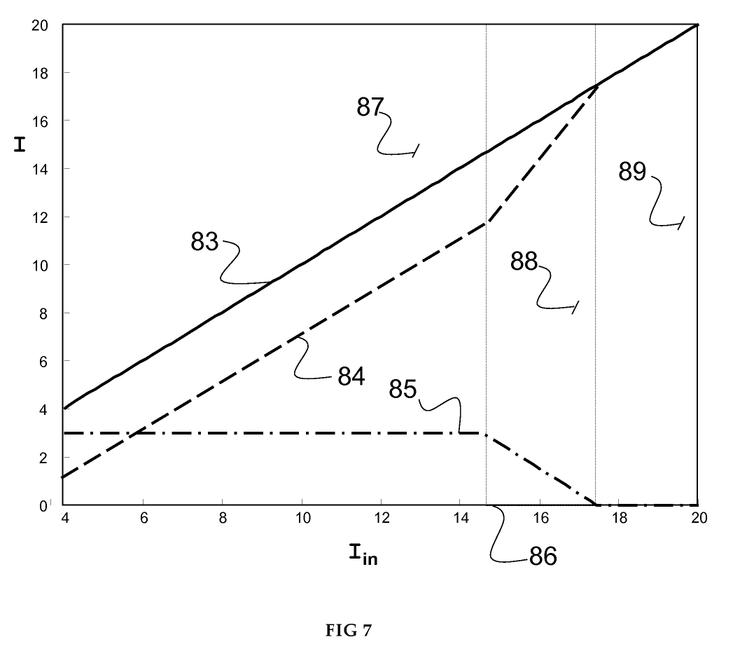

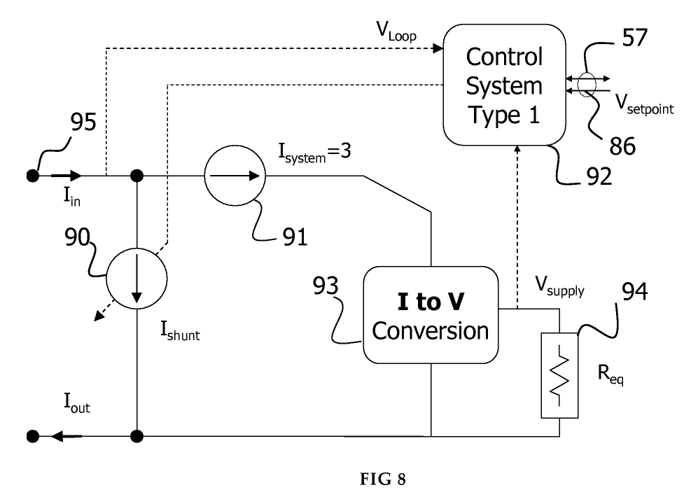

FIG. 7 depicts a representation of the operation of the current-mode power-extraction system. The simplified circuit shown in FIG. 8 shows a shunt current, 90, that is controlled by the Control System, 92 and is adjusted to ensure that the input system current, 91, is balanced against the output current, Iₒᵤₜ. The feedback mechanism, 92, is a simplified representation of the instrumentation amplifier, 76a. The equivalent load resistor, 94, is the measurement point for the voltage, Vsupply. The Control System 93 sets the Loop Voltage, 95, so that it matches the input control voltage set by Vsetpoint 86. As the loop current increases from 4 to 20 mA, 83, in the Current Limited Charging operating region 87 the current shunted is increased from 0 to 20 mA and is dependant on the system load current 91 as depicted by curve 85 in FIG. 7. When the Supply Voltage exceeds the set point voltage 86 the system begins to operate in the Partial Charge 88 region and the current used by the system decreases and is taken up by the shunted current 90 as depicted by curve 84 in FIG. 7 until the system reaches the Fully Charged 89 region. In this situation, the current available for power extraction is 4 mA over the range of the loop current.

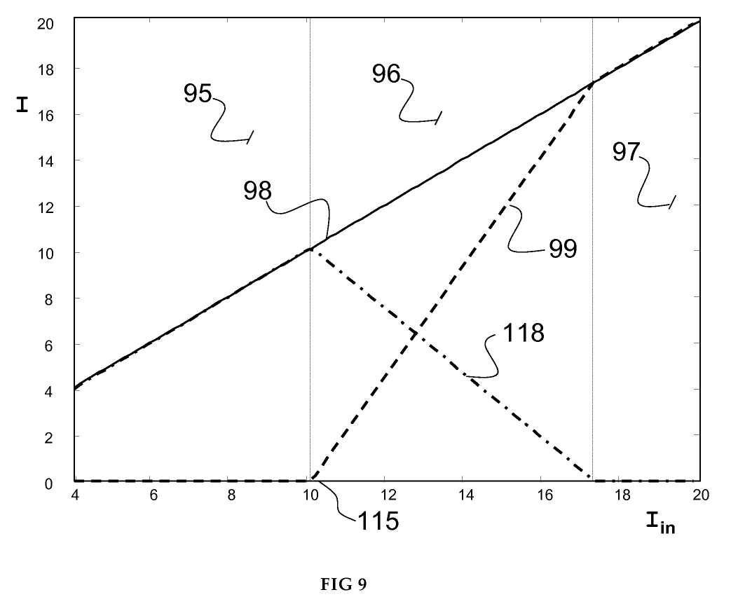

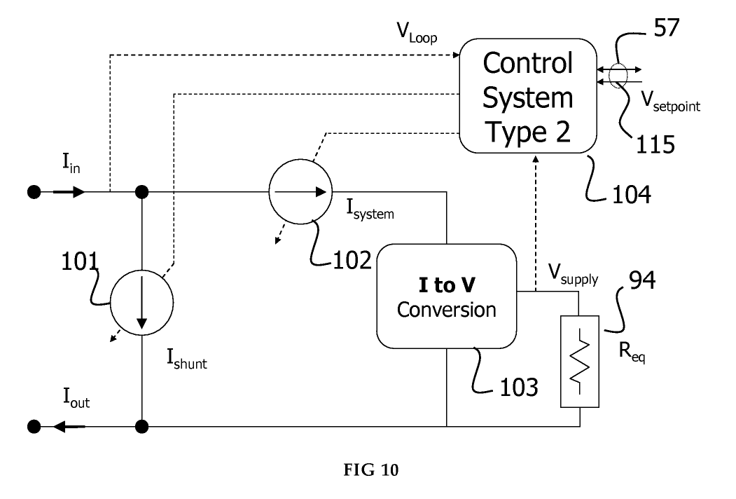

In another instantiation of the current-mode power-extraction subsystem, the current used by the shunt, 101, in FIG. 10, is depicted by the curve, 99, in FIG. 9. The current available for the system 102 is depicted by curve 118 in FIG. 9. A feedback Control System, 104, is used to maintain a balance between the current used in the loop 98 and the sum of the shunt, 99, and system (load, 118), currents. This is accomplished by means of the connected controlled current source 101 and 102. In this embodiment, the voltage set point 115 is reached at a lower loop current 98 than in the first embodiment, FIG. 9. The Current Limited Charging region 95 is active over a smaller range of current allowing a larger Partial Charge region 96 while the total system power is increased to the Fully Charged region 97 achieved up to the maximum loop current. Control system 104 adjusts the system current 102 to regulate a supply voltage on the load 94. The loop current is maintained by regulating the shunt current 101 so that the load current 102 and the shunt current 101 equals the loop current. These controls are set by the input control signals 57.

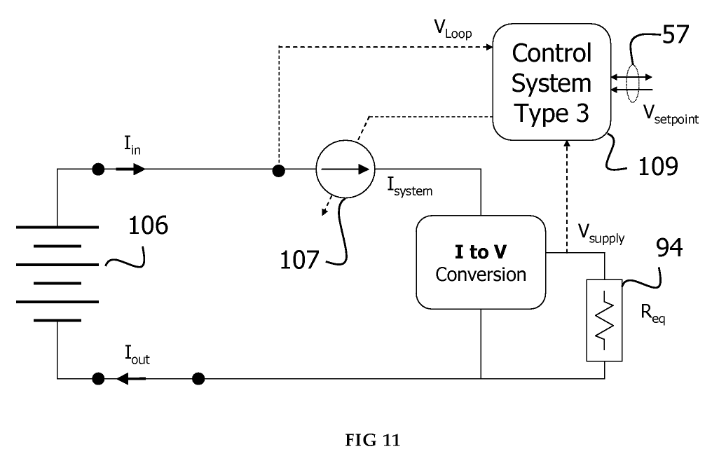

In FIG. 11, a primary voltage source, 106, is used to deliver power to the current source, 107, that pumps current to the output load, 94. The set current is adjusted so that the current pump matches the current source, 107 and the voltage difference between the loop voltage and the supply current pump charge voltage is minimized.

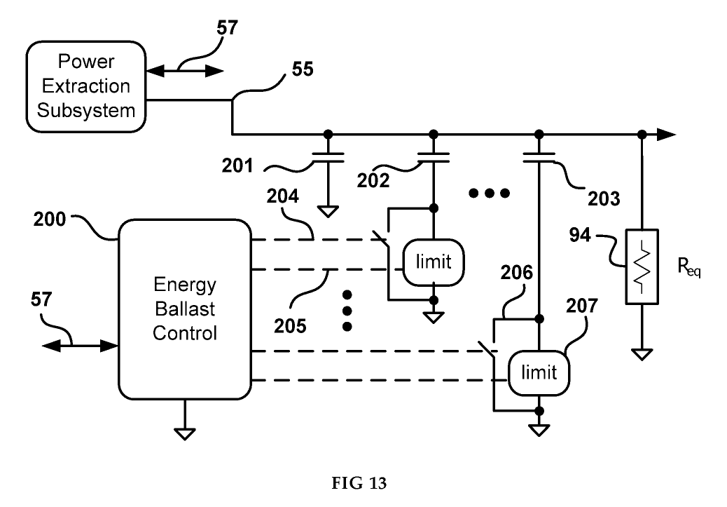

In all such power sources, energy-storage devices are required to maintain a regulated supply for the internal load of the system. In FIG. 13, the energy storage device 201 is selected to store only enough energy to allow proper regulation of the supply. This ensures that the system supply can turn on quickly and recovery rapidly from a power source disturbance. There are one or more additional storage elements 202, 203 that are available for energy storage when the system energy required by the load, 94 (R_{eq}), is less than that available form the power extraction circuit 52. The first storage element must reach capacity quickly to enable rapid turn-on, but the system load variation may require additional energy demands from time to time for proper function. An energy rate limiter 207 is controlled by the Energy Ballast Control mechanism 200 to manage the rate of energy storage into the excess ballast. Once the ballast has been fully charged, an external switch 206 is closed and latched to further increase the efficiency of the energy storage devices 202, 203. Control of the Energy Ballast Control is done through the Controller Control-Signals 57. In the present embodiment, the choice of storage element capacities is done in such a way to balance the peak current 70 against the maximum power threshold 60 for fast cutover operation between the auxiliary power source and short-term energy storage.

In this disclosure, we have described the use of local power sources to augment loop power in field devices using wireless communication in a process monitoring system. We describe a method of augmenting loop power with a plurality of local power sources using a specialized embodiment of a control mechanism that automates and optimizes available power sources, thereby increasing the functionality and operational conditions under which the wireless field device may operate. Again, the embodiments described herein are meant to be illustrative and are not intended as limiting. In addition, various features described above may be combined in any suitable way to form a system in accordance with the invention.

We claim:

1. Apparatus having multiple power sources comprising:
a transceiver for producing and receiving wireless signals;
at least one auxiliary power source; and
a controller for providing power to the transceiver from a primary power source including a current loop and the at least one auxiliary power source by augmenting the primary power source with the auxiliary power source when demand exceeds power available from the primary power source.

2. The apparatus of claim 1 further including a memory in which a record indicative of auxiliary power usage is stored.

3. The apparatus of claim 2 wherein the record includes an indication of at least one condition indicative of when auxiliary power is required.

4. The apparatus of claim 3 wherein the controller is further operable to make auxiliary power available based on the at least one condition indicative of when auxiliary power is required.

5. The apparatus of claim 4 wherein the condition includes at least one of time and temperature.

6. The apparatus of claim 1 wherein the auxiliary power source includes at least one of solar cells, harvesters that convert mechanical energy to electrical energy, collectors of stray electromagnetic radiation, wind turbines, tidal power collectors, systems powered by wave action, geothermal systems, systems using thermoelectric effects, systems using temperature differentials and systems using pressure differentials.

7. The apparatus of claim 1 further including at least one nonlinear device for delivering current to the transceiver or other system load.

8. The apparatus of claim 1 further including means for communicating power source state.

9. The apparatus of claim 1 further including means for communicating power requirement state.

10. A method for managing multiple power sources comprising:
providing power to a load from a primary power source including a current loop and at least one auxiliary power source; and
augmenting the primary power source with auxiliary power when demand exceeds power available from the primary power source; and
controlling and sequencing the primary and auxiliary power to reduce system turn-on time.

11. The method of claim 10 further including the step of storing a record indicative of auxiliary energy usage.

12. The method of claim 11 including the step of storing a record including at least one condition indicative of when auxiliary power is required.

13. The method of claim 12 including the step of making auxiliary power available based on the at least one condition indicative of when auxiliary power is required.

14. The method of claim 13 including the step of storing a condition including at least one of time and temperature.

15. The method of claim 10 including the step of providing auxiliary power with at least one of solar cells, harvesters that convert mechanical energy to electrical energy, collectors of stray electromagnetic radiation, wind turbines, tidal power collectors, systems powered by wave action, geothermal systems, systems using thermoelectric effects, systems using temperature differentials and systems using pressure differentials.

16. The method of claim 10 including the step of delivering current to the load with at least one nonlinear device.

17. The method of claim 10 including the step of communicating power source state.

18. The method of claim 10 including the step of communicating power requirement state.
